(19) United States
(12) Patent Application Publication
(10) Pub. No.: US 2011/0181636 A1
(43) Pub. Date: Jul. 28, 2011

(54) PROJECTION APPARATUS AND IMAGE BLUR PREVENTIVE CONTROL METHOD FOR PROJECTION APPARATUS

(75) Inventor: Osamu Fukazawa, Matsumoto-shi (JP)

(73) Assignee: Seiko Epson Corporaton, Tokyo (JP)

(21) Appl. No.: 13/009,057

(22) Filed: Jan. 19, 2011

(30) Foreign Application Priority Data
Jan. 26, 2010 (JP) 2010-013935

(51) Int. Cl. G09G 5/02; G02B 27/64

(52) U.S. Cl. 345/697; 359/554; 359/557

(57) ABSTRACT

A projection apparatus includes: a projection system which projects an image; a vibration detecting unit which detects vibration given to the main body of the apparatus; an installation condition determining unit which determines the installation condition of the main body of the apparatus; and an image blur preventive control unit which performs image blur preventive control for preventing blurring of the image caused by the vibration detected by the vibration detecting unit based on the vibration, wherein the image blur preventive control unit performs the image blur preventive control in accordance with the installation condition determined by the installation condition determining unit.

### BACKGROUND

1. Technical Field

The present invention relates to a projection apparatus which projects images toward a screen and an image blur preventive control method for the projection apparatus.

2. Related Art

A projection apparatus (projector) of a type which detects blurring of an image caused by vibration of hand and corrects the image in accordance with the amount of the blur is known (for example, see WO2005/083507). The projection apparatus having this structure prevents blurring of a projection image (image blur) caused by vibration of hand while the projection apparatus held by hand is projecting the image.

A typical projection apparatus is not a type held by hand as described above but a type fixed for installation. The fixed installation type includes a normal installation type disposed on a desk or the like, and a suspension type suspended from above such as a type suspended from a ceiling or a wall. In case of the fixed installation, it generally seems that there is no possibility of image blur. In fact, however, vibration given to the main body of the apparatus has a large effect even on the fixed installation, and image blur caused by the vibration makes an observer uncomfortable. Particularly, in case of the suspension type, the projection apparatus is easily affected by vibration of the ceiling or the wall. For avoiding this problem, the ceiling and the wall around the installation position of the projection apparatus and fittings for installation of the projection apparatus need to be strengthened. This necessity greatly increases the cost. When a bar-shaped component (pipe) is included in the fittings for installation, the projection apparatus is fixed to the tip of the bar-shaped component. In this case, even a slight movement of the ceiling or the wall amplifies vibration of the main body of the apparatus via the bar-shaped component. Accordingly, even when construction for installation requiring high cost is completed, image blur caused by vibration cannot be perfectly prevented.

### SUMMARY

An advantage of some aspects of the invention is to provide a projection apparatus and an image blur preventive control method for the projection apparatus capable of effectively preventing image blur caused by vibration of the main body of the projection apparatus.

A projection apparatus according to one aspect of the invention includes: a projection system which projects an image; a vibration detecting unit which detects vibration given to the main body of the apparatus; an installation condition determining unit which determines the installation condition of the main body of the apparatus; and an image blur preventive control unit which performs image blur preventive control for preventing blurring of the image caused by the vibration detected by the vibration detecting unit based on the vibration. The image blur preventive control unit performs the image blur preventive control in accordance with the installation condition determined by the installation condition determining unit.

An image blur preventive control method for a projection apparatus which projects an image according to another aspect of the invention includes: allowing the projection apparatus to detect vibration given to the main body of the apparatus; allowing the projection apparatus to determine the installation condition of the main body of the apparatus; and allowing the projection apparatus to perform image blur preventive control for preventing blurring of the image caused by the vibration given to the main body of the projection apparatus and detected by the projection apparatus based on the vibration. The image blur preventive control performed by the projection apparatus for preventing blurring of the image is conducted in accordance with the detected installation condition of the main body of the projection apparatus.

According to these aspects of the invention, blurring of the image (oscillation or inclination of the image) caused by the vibration given to the main body of the apparatus (vibration of the main body of the apparatus) can be effectively prevented by the image blur preventive control performed in accordance with the installation condition (such as suspended condition from above and normal installation) of the main body of the apparatus.

The vibration detecting unit may be disposed on the main body of the apparatus or on the installation place of the projection apparatus (such as a ceiling, a wall, and an installation stand).

In the projection apparatus of the above aspect, it is preferable that the image blur preventive control unit performs the image blur preventive control only when the installation condition determining unit determines that the main body of the apparatus is in a predetermined installation condition.

According to this structure, the image blur preventive control is performed only when it is determined that the main body of the apparatus is in the predetermined installation condition. Accordingly, unnecessary control is not executed, and thus the control load can be reduced.

In the projection apparatus of the above aspect, it is preferable that the predetermined installation condition is a suspended condition from above.

According to this structure, the image blur preventive control is performed only when the installation condition is the suspended condition from above. Thus, when the main body of the apparatus is attached to a ceiling or a wall by using a bar-shaped installation component and greatly vibrated by movement of the ceiling or the wall, for example, blurring of the image caused by the vibration can be prevented.

The installation condition determining unit may be so constructed as to detect not only whether the installation condition is the suspended condition or not but also whether the projection apparatus is attached by using a bar-shaped component. According to this structure, blurring of the image can be more effectively prevented in accordance with the installation condition.

In the projection apparatus of the above aspect, it is preferable that the projection apparatus further includes a projection mode setting unit which sets a projection mode corresponding to the installation condition of the main body of the apparatus. In this case, the installation condition determining unit determines the installation condition of the main body of the apparatus based on the setting of the projection mode setting unit.

According to this structure, the installation condition of the main body of the apparatus can be accurately and easily determined based on the setting result of the projection mode selected by a user.

In the projection apparatus of the above aspect, it is preferable that the image blur preventive control unit performs the image blur preventive control for the projection system.

According to this structure, the image blur preventive control can be easily performed by controlling the optical axis using the projection system.

In the projection apparatus of the above aspect, it is preferable that the image blur preventive control unit executes angle control of an optical axis correction lens provided on the light entrance side of a projection lens as the image blur preventive control.

According to this structure, the optical axis correction lens is disposed on the light entrance side of the projection lens. In this case, the angle correction amount becomes smaller than that amount required when the projection lens is disposed on the light exit side of the projection lens. Also, adjustment required in case of after-attachment of the optical axis correction lens is eliminated.

In the projection apparatus of the above aspect, it is preferable that the projection apparatus further includes an image processing unit which carries out image processing for an inputted image signal. The image blur preventive control unit performs the image blur preventive control for the image processing unit.

According to this structure, blurring of the image is prevented by the image processing. Thus, the necessity for adding components for providing the advantages of the invention (such as the optical axis correction lens) is eliminated. Accordingly, cost increase can be reduced.

### BRIEF DESCRIPTION OF THE DRAWINGS

The invention will be described with reference to the accompanying drawings, wherein like numbers reference like elements.

FIG. 1 is a block diagram showing the structure of a projector according to a first embodiment.

FIGS. 2A through 2D illustrate projection modes of the projector.

FIG. 3 schematically illustrates a projection system (liquid crystal type).

FIG. 4 schematically illustrates a projection system (micromirror device type).

FIG. 5 is a block diagram showing the structure of a projector according to a second embodiment.

FIG. 6 is a side view of the projector in a suspended condition from above.

FIG. 7 schematically illustrates a projector combined with a white board.

### DESCRIPTION OF EXEMPLARY EMBODIMENTS

### First Embodiment

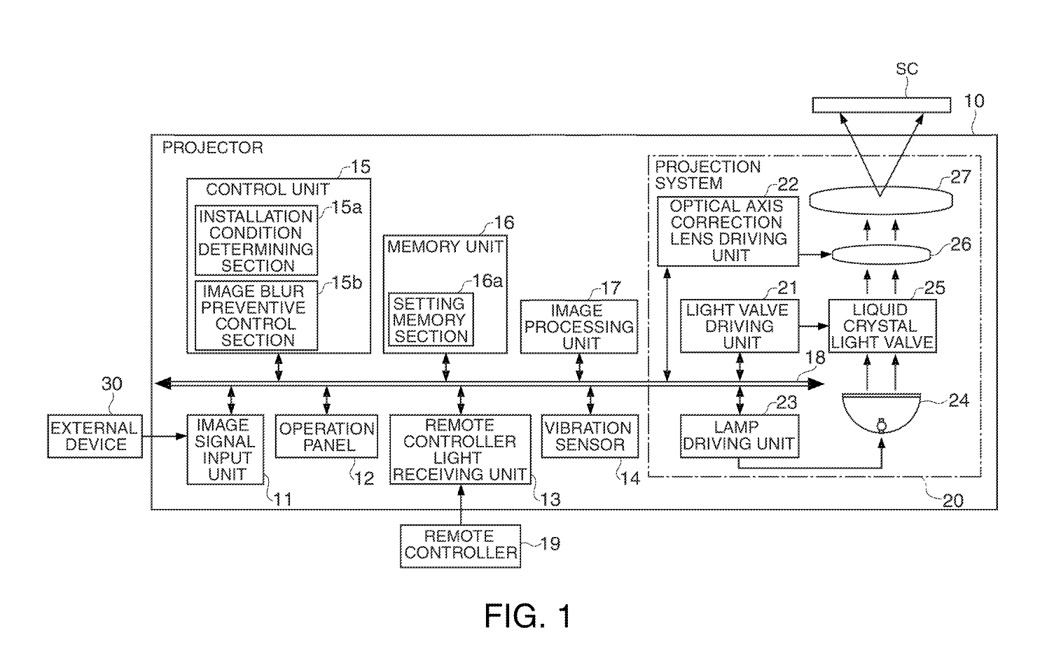

A projection apparatus (projector 10) and an image blur preventive control method for the projection apparatus according to a first embodiment of the invention are hereinafter described with reference to the drawings. FIG. 1 is a block diagram showing the structure of the projector 10. As shown in the figure, the projector 10 includes an image signal input unit 11, an operation panel 12, a remote controller light receiving unit 13, a vibration sensor 14 (vibration detecting unit), a control unit 15, a memory unit 16, an image processing unit 17, a bus line 18, and a projection system 20.

The image signal input unit 11 has a plurality of image input terminals to which various types of image signals are inputted from an external device 30 such as a personal computer and a video player. The operation panel 12 is provided on the main body of the projector 10, and has a group of buttons operated for performing various operations. The group of buttons include a menu button for displaying an environment setting menu, and a direction button and a decision button for selecting modes. The remote controller light receiving unit 13 receives light containing operation signals (infrared signals) from a remote controller 19. The remote controller 19 is a component operated for remote control of the main body of the projector 10, and has a group of various buttons similarly to the operation panel 12.

The vibration sensor 14 is a sensor for detecting vibration of the main body of the projector 10, and includes a vertical detection gyro sensor and a horizontal detection gyro sensor (neither of these are shown). The “vibration” herein refers to at least a vibration cycle and a vibration width in three-dimensional directions. The vibration sensor 14 may be a combination of a displacement sensor, a speed sensor, an acceleration sensor and others as well as gyro sensors.

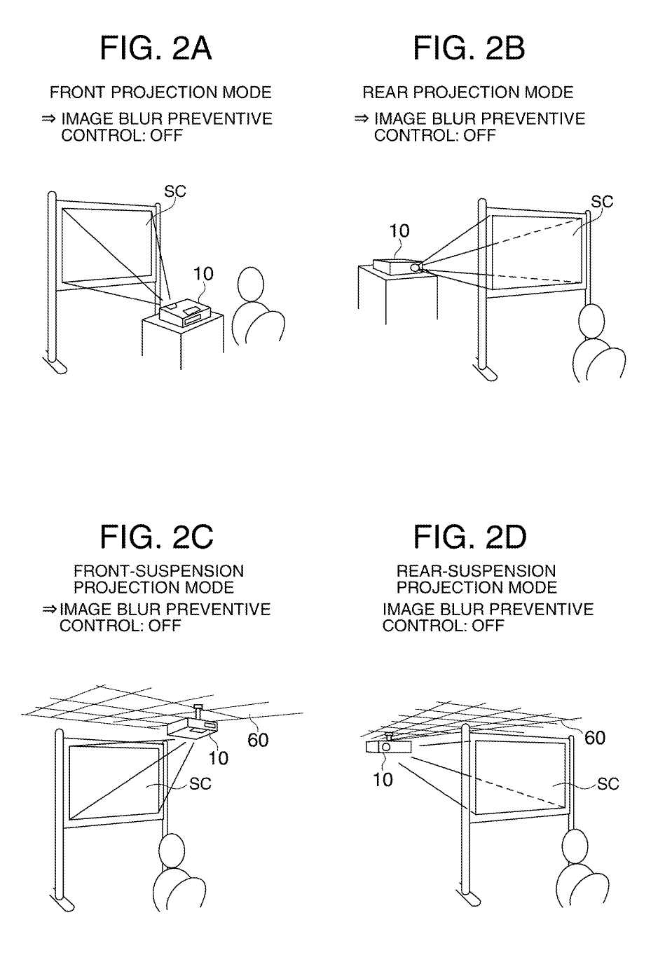

The control unit 15 includes a CPU (central processing unit) and others, and transmits and receives signals to and from the respective units via the bus line 18 to supervise and control the entire operation of the projector 10. The control unit 15 further includes an installation condition determining section 15a and an image blur preventive control section 15b. The installation condition determining section 15a determines the installation condition of the main body of the projector 10. More specifically, the installation condition determining section 15a determines the installation condition based on a projection mode (see FIGS. 2A through 2D) set by a user. The image blur preventive control section 15b performs image blur preventive control for preventing blurring of a projection image caused by vibration of the main body of the projector 10 (for canceling the effect of the vibration given to the projection image) in accordance with the installation condition determined by the installation condition determining section 15a. More specifically, when the projection mode selected by the user is a “suspension projection mode”, the image blur preventive control is performed for the projection system 20. The details of the installation condition determining section 15a and the image blur preventive control section 15b will be described later.

The memory unit 16 contains a ROM (read only memory) for storing control programs and control data used for the control by the control unit 15, a RAM (random access memory) used as a work area, and others (none of these are shown). The control programs include an optical axis correcting program used for achieving the image blur preventive control. The memory unit 16 has a setting memory section 16a for storing setting values of various modes (including the projection modes).

The image processing unit 17 performs predetermined image processes for image signals received from the image signal input unit 11, and outputs the processed image signals to a light valve driving unit 21. The predetermined image processes include an image reverse process, a keystone distortion correction process, an image quality control process, an image size control process, a gamma correction process and others. The vibration sensor 14 (gyro sensor) is used for the keystone distortion correction process as well.

The projection system 20 is a system of a liquid crystal type, including the light valve driving unit 21, an optical axis correction lens driving unit 22, a lamp driving unit 23, a light source lamp 24, a liquid crystal light valve 25, an optical axis correction lens 26, and a projection lens 27.

The light valve driving unit 21 as a driver for driving the liquid crystal light valve 25 applies driving voltage corresponding to the image signals to respective pixels of the liquid crystal light valve 25 to set light transmissivity of the respective pixels. The optical axis correction lens driving unit 22 as a driver for controlling the angle of the optical axis correction lens 26 is controlled by the image blur preventive control section 15b.

The lamp driving unit 23 as a driver for turning on the light source lamp 24 constituted by a discharge light emission type lamp has an igniter section which generates high voltage to form a discharge circuit, and a ballast circuit which maintains a stable lighting condition after lighting (neither of these are shown).

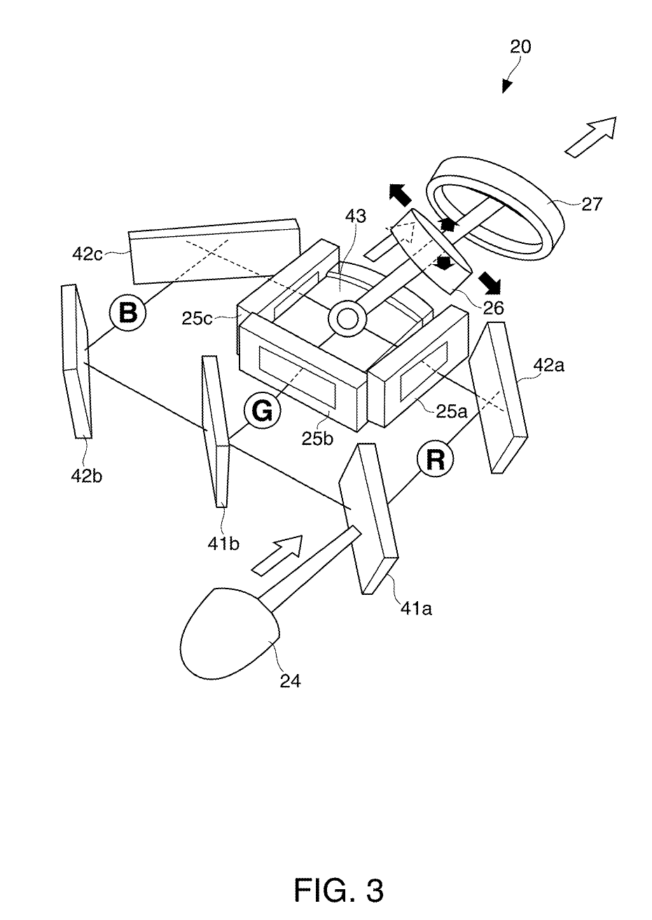

According to this structure, light emitted from the light source lamp 24 is divided into color lights in R, G, and G by the function of alight separating system (dichroic mirror 41, see FIG. 3), and then modulated while passing through the liquid crystal light valve 25 for the respective colors. The modulated image lights are combined by a light combining system (dichroic prism 43, see FIG. 3) for each pixel to produce a color image. Then, the image light converted into color image light is released through the optical axis correction lens 26 and the projection lens 27 to be displayed as a projection image on a screen SC.

The four types of projection modes are now described with reference to FIGS. 2A through 2D. As explained above, the user can select one of the four types of projection modes shown in FIGS. 2A through 2D. For the setting, the user operates the operation panel 12 or the remote controller 19 to display the environment setting menu on the screen SC as the OSD (on screen display), and then operates the direction button and the decision button displayed thereon (projection mode setting unit).

A front projection mode shown in FIG. 2A is selected at the time of projection from the front toward the screen SC. A rear projection mode shown in FIG. 2B is selected at the time of projection from the back of the rear-type (transmission-type) screen SC. In this case, the image processing unit 17 performs a horizontal reverse process for the image. A front-suspension projection mode shown in FIG. 2C is selected at the time of projection from the front of the screen SC with the main body of the projector 10 suspended from above. In this case, the image processing unit 17 performs a vertical reverse process for the image. A rear-suspension projection mode shown in FIG. 2D is selected at the time of projection from the back of the rear-type screen SC with the main body of the projector 10 suspended from above. In this case, the image processing unit 17 performs the horizontal reverse process and the vertical reverse process for the image. According to this embodiment, the image blur preventive control is carried out only when the front-suspension projection mode shown in FIG. 2C and the rear-suspension projection mode shown in FIG. 2D in the four types of projection modes are set. In other words, when the front projection mode shown in FIG. 2A and the rear projection mode shown in FIG. 2B are selected, the image blur preventive control is not executed even in the condition that vibration has been detected by the vibration sensor 14.

The details of the liquid crystal type projection system 20 and the image blur preventive control performed for the projection system 20 are now explained with reference to FIG. 3. FIG. 3 schematically illustrates an example of the projection system 20 according to this embodiment. The projection system 20 includes the light source lamp 24, the liquid crystal light valve 25, the optical axis correction lens 26, and the projection lens 27 shown in FIG. 1, and further the dichroic mirror 41, a mirror 42, and the dichroic prism 43.

The light source lamp 24 is constituted by an extra-high pressure mercury lamp, a metal halide lamp, a xenon lamp or the like, for example. Alternatively, the light source lamp 24 may be selected from various types of self-light-emission elements such as a light emitting diode, an organic EL element, a silicon light emitting element, and a laser diode as well as the discharge light emission type lamps.

The liquid crystal light valve 25 has three color liquid crystal light valves 25a, 25b, and 25c corresponding to three primary colors (R, G and B). Each of the liquid crystal light valves 25a, 25b, 25c has a liquid crystal panel and polarization plates disposed on the entrance side and the exit side of the liquid crystal panel (none of these are shown). The liquid crystal panel is of a type which uses polysilicon TFTs (thin film transistors) as switching elements, for example.

Each of the optical axis correction lens 26 and the projection lens 27 is a combination of a plurality of lenses. The angle of the optical axis correction lens driving unit 22 (see FIG. 1) for driving the optical axis correcting lens 26 is controlled by the image blur preventive control section 15b in accordance with vibration given to the main body of the projector 10 such that no blur is produced on the projection image on the screen SC. That is, the optical axis correction lens driving unit 22 controls the angle of the optical axis correction lens 26 such that deviation of the optical axis caused by vibration can be cancelled when the vibration is given to the main body of the projector 10. The image blur preventive control section 15b performs the control only when the projection mode is the suspension projection mode. More specifically, the image blur preventive control section 15b refers to the setting memory section 16a storing the setting value of the projection mode and executes the image blur preventive control based on the detection result obtained by the vibration sensor 14 only when the setting value indicates the suspension projection mode.

The dichroic prism 43 is an optical element which combines the respective color lights modulated by the liquid crystal light valve 25 to form a color image. The dichroic prism 43 has an approximately square shape in the plan view produced by affixing four rectangular prisms, and two types of dielectric multilayer films are disposed in an X shape on the interfaces of the four rectangular prisms. These dielectric multilayer films reflect the color lights (R, B) received from the liquid crystal light valves 25a and 25c opposed to each other, and transmit the color light (G) received from the liquid crystal light valve 25b opposed to the projection lens 27. By this method, the dichroic prism 43 combines the respective color lights (R, G, and B) to produce a color image.

According to this structure, light emitted from the light source lamp 24 is divided into the respective color lights by the function of dichroic mirrors 41a and 41b. Then, the red light reflected by a mirror 42a enters the red liquid crystal light valve 25a, the green light coming from the dichroic mirror 41b enters the green liquid crystal light valve 25b, and the blue light reflected by mirrors 42b and 42c enters the blue liquid crystal light valve 25c. The lights having entered the respective liquid crystal light valves 25a, 25b, and 25c are modulated according to image signals, and enter the dichroic prism 43. The dichroic prism 43 combines the respective color lights modulated by the liquid crystal light valves 25a, 25b, and 25c to form a color image, and releases the formed color image toward the optical axis correction lens 26. The light having entered the optical axis correction lens 26 is controlled by the image blur preventive control section 15b such that the optical axis of the light can be fixed, and then expanded and projected by the projection lens 27.

Accordingly, the image blur preventive control is performed only when the projector 10 is in the suspended condition in the first embodiment. This is because the projector 10 is easily affected by vibration of a ceiling 60 or the like under the suspended condition. Particularly, when a bar-shaped component is included in installation fittings (supporting members) as a component having a tip to which the projector 10 is fixed, slight movement of the ceiling 60 is transmitted through the bar-shaped component to the main body of the projector 10 and amplifies vibration of the main body of the projector 10. However, when the image blur preventive control is carried out only at the time of the suspended condition of the projector 10, disorder of the projection image caused by vibration given to the main body of the projector 10 can be efficiently and effectively prevented. Moreover, the installation condition of the projector 10 is determined based on the result of setting of the projection mode selected by the user. Thus, the installation condition can be accurately and easily determined.

Furthermore, the image blur preventive control section 15b carries out the image blur preventive control for the optical axis correction lens 26 of the projection system 20, and thus can easily achieve adjustment of the optical axis. In addition, since the optical axis correction lens 26 is disposed on the light entrance side of the projection lens 27, the angle correction amount becomes smaller than that amount required when the optical axis correction lens 26 is disposed on the light exit side of the projection lens 27. Also, adjustment required in case of after-attachment of the optical axis correction lens 26 is eliminated.

While the projection system 20 of the transmission type liquid crystal system has been discussed in this embodiment, the display may be based on a reflection type liquid crystal display system, a CRT display system, a micromirror device system (light switch display system), or other display systems.

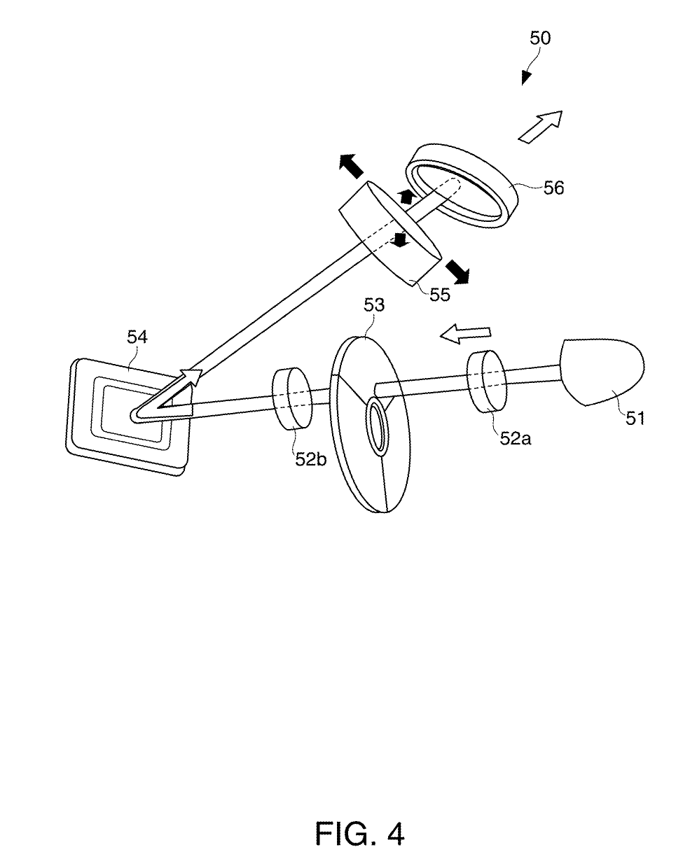

The type of the micromirror device system has the following structure. FIG. 4 schematically illustrates an example of a projection system 50 of the micromirror device system. The projection system 50 of the micromirror device system includes a light source lamp 51, various lenses 52a and 52b, a color wheel 53, a micromirror device 54 (DMD: digital micromirror device), an optical axis correction lens 55, and a projection lens 56. According to the micromirror device system, the optical axis correction lens 55 is provided on the light entrance side of the projection lens 56 similarly to the liquid crystal system. Thus, advantages similar to those of the liquid crystal system discussed above can be provided by performing the image blur preventive control based on detected vibration. In case of the micromirror device system, the optical axis may be controlled by adjusting angles of respective small mirrors constituting the DMD 54. That is, the image blur preventive control may be performed for the DMD 54.

### Second Embodiment

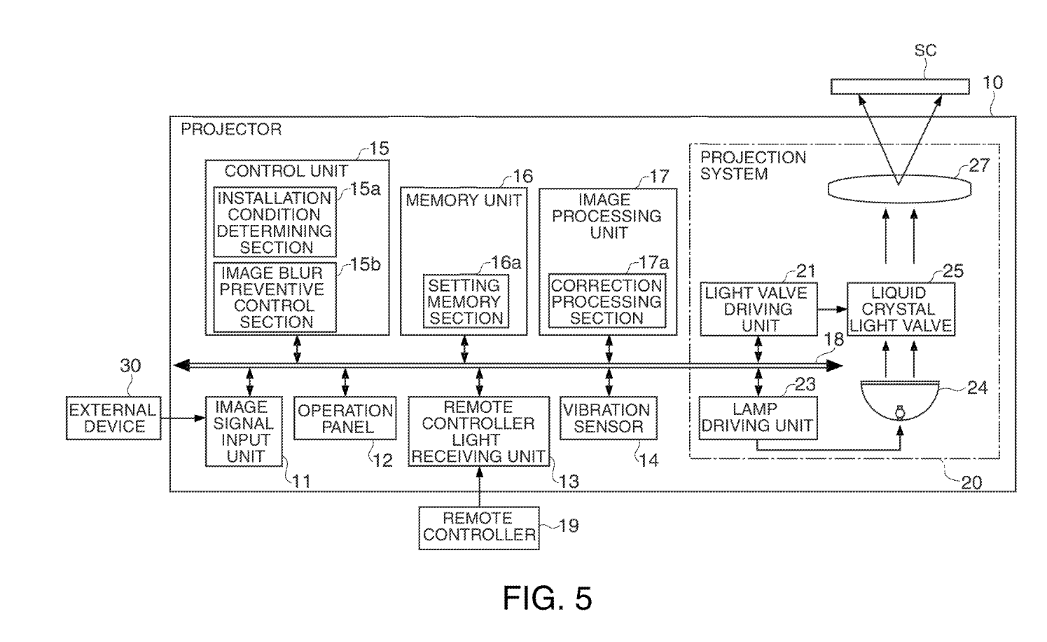

A second embodiment is now described with reference to FIG. 5. This embodiment is different from the first embodiment in that the image blur preventive control is performed not for the projection systems 20 and 50 as in the first embodiment but for the image processing unit 17. In the following explanation, only the parts different from the corresponding parts in the first embodiment are discussed. In the second embodiment, the same reference numbers are given to components same as those in the first embodiment, and the same detailed explanation is not repeated. Modified examples applied to the structures in the first embodiment are similarly applied to the corresponding structures in the second embodiment.

FIG. 5 is a block diagram showing the structure of the projector 10 according to the second embodiment. The projector 10 in this embodiment is different from that in the first embodiment in that the optical axis correction lens driving unit 22 and the optical axis correction lens 26 are removed from the projection system 20. In place of these components, a correction processing section 17a is provided within the image processing unit 17. In this embodiment, therefore, the image blur preventive control section 15b carries out the image blur preventive control for preventing image blur for the image processing unit 17 (correction processing section 17a) based on vibration detected by the vibration sensor 14.

The correction processing section 17a executes a correction process for image signals inputted from the image signal input unit 11 in response to a command issued from the image blur preventive control section 15b. The correction process performed in this step is a process of cutting out a frame from an original image and shifting the cut out frame toward the opposite side in accordance with the detected vibration for correction, for example. By this method, image blur caused by the effect of vibration can be prevented even when the vibration is generated on the ceiling 60 or the like and transmitted to the main body of the projector 10.

According to the second embodiment, therefore, image blur can be prevented by executing the image processing. In this case, the necessity for adding components for providing the advantages of the invention (such as the optical axis correction lens 26) is eliminated. Thus, cost increase can be reduced.

According to the respective embodiments, whether the image blur preventive control is necessary or not is determined according to the installation condition of the main body of the projector 10. However, not the necessity of the image blur preventive control but the necessity of actuation of the vibration sensor 14 may be determined. In this structure, the advantages of the invention can be provided only by the simple control of switching between ON and OFF of the vibration sensor 14.

It is possible to perform the image blur preventive control corresponding to the installation condition of the main body of the projector 10 rather than to determine the necessity for the image blur preventive control in accordance with the installation condition of the main body of the projector 10. According to this structure, the image blur preventive control is executed in the normal projection mode but is controlled such that the angle correction amount (shift amount) of the optical axis correction lens 26 and the sensitivity of the vibration sensor 14 in the normal projection mode become smaller and lower than those in the suspension projection mode, for example.

It is possible to provide a function which forces the image blur preventive control to be turned off even in the condition of the suspension projection mode, and forces the image blur preventive control to be turned on even in the condition of the normal projection mode.

According to the respective embodiments, the installation condition of the main body of the projector 10 is determined based on the selected projection mode. However, the installation condition of the main body of the projector 10 may be automatically detected by using a gravity sensor or the like. According to this structure, the labor of the user for setting the projection mode can be eliminated. In this case, it is preferable that the image processing unit 17 carries out the vertical reverse process in accordance with the installation condition automatically detected.

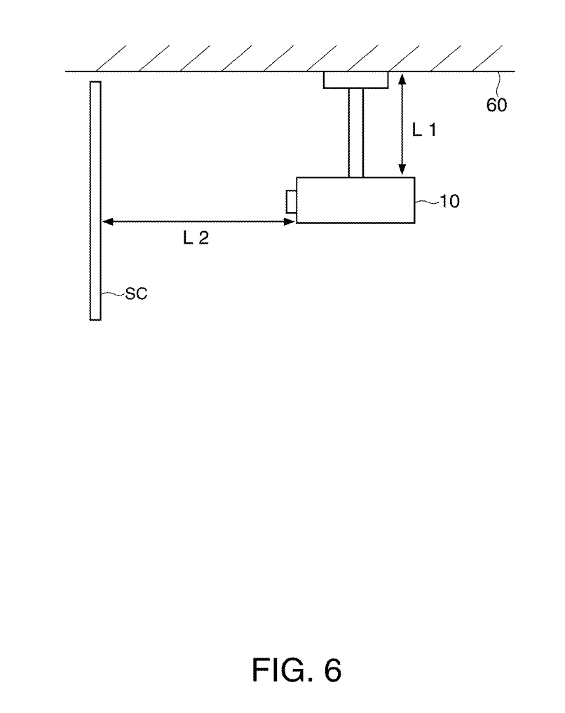

According to the respective embodiments, the installation condition determining section 15a determines only whether the installation condition is the suspended condition or not. However, a distance L1 from the ceiling 60 or a distance L2 from the screen SC in the suspended condition may be determined as illustrated in FIG. 6. This figure is aside view illustrating the projector 10 suspended from above with the projection opening of the projector 10 facing to the screen SC (the left side in the figure). In this case, the image blur preventive control is performed based on at least either the distance L1 from the ceiling 60 or the distance L2 from the screen SC. According to this control, the angle correction amount of the optical axis correction lens 26 or the sensitivity of the vibration sensor 14 is increased as the distance L1 or the distance L2 becomes longer, for example. The distance L1 and the distance L2 can be measured by a distance sensor using laser beams or infrared beams.

According to the explanation herein, the image processing unit 17 performs the keystone distortion correction process. In this case, the image blur preventive control may be executed in accordance with the level (tilt angle) of the keystone distortion correction. According to this control, the angle correction amount of the optical axis correction lens 26 or the sensitivity of the vibration sensor 14 is increased as the tilt angle becomes larger, for example.

The installation condition determining section 15a may detect whether the projector 10 is attached via a bar-shaped installation component. For example, the installation condition can be determined as the suspended condition when the installation component is used. Furthermore, after determining the type of the installation component, the image blur preventive control may be executed in accordance with the determined type of the installation component. According to this control, the angle correction amount of the optical axis correction lens 26 or the sensitivity of the vibration sensor 14 is raised as the length of the installation component becomes larger, for example. Accordingly, more effective image blur preventive control corresponding to the installation condition can be achieved by detecting the distance L1 from the ceiling 60, the distance L2 from the screen SC, the level of the keystone distortion correction, and the presence or absence and the type of the installation component.

While the vibration sensor 14 is provided on the main body of the projector 10 in the respective embodiments, the vibration sensor 14 may be equipped separately from the main body of the projector 10. For example, the vibration sensor 14 may be disposed on the installation place of the projector 10 (such as the ceiling 60, a wall, and an installation stand). In this case, the detection result obtained by the vibration sensor 14 needs to be transmitted to the main body of the projector 10 through short distance wireless communication or infrared communication. Alternatively, the vibration sensor 14 may be equipped on the remote controller 19 such that the vibration of the wall or the installation stand can be detected. In case of the structure which includes the vibration sensor 14 separately from the main body of the projector 10, the image blur preventive control may be performed in accordance with the distance L1 from the ceiling 60, the distance L2 from the screen SC, and the presence or absence and the type of the installation component in the similar manner as explained above.

The vibration sensor 14 may be provided both on the main body of the projector 10 and on the installation place of the projector 10. In this case, the image blur preventive control is performed based on the detection results obtained by both of the vibration sensors 14.

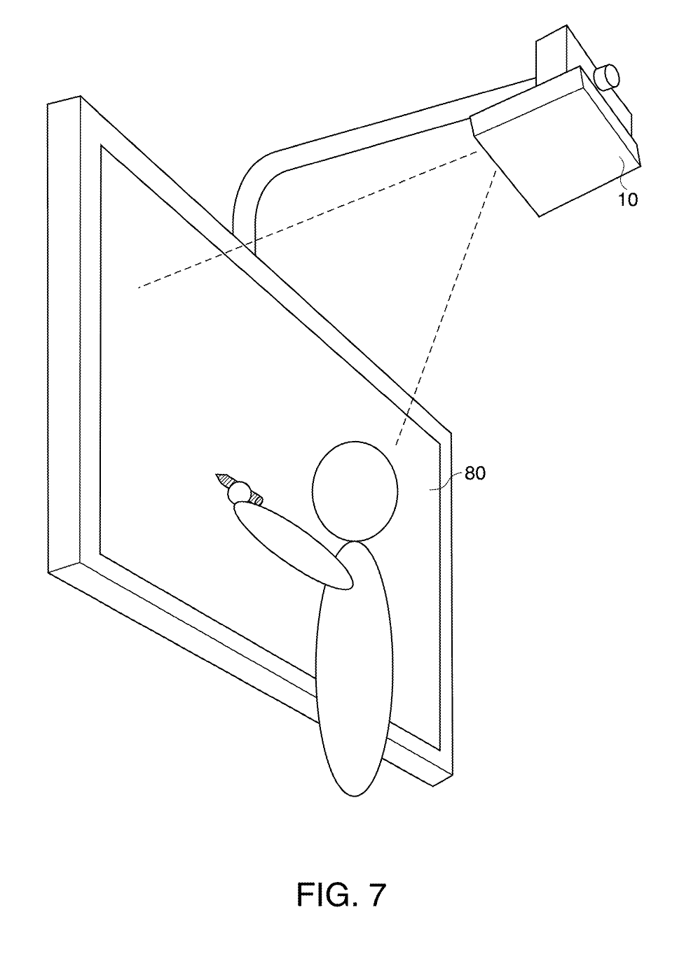

As an example of the suspension installation from above, such a structure combined with a white board as illustrated in FIG. 7 is expected. In this case, the vibration sensor 14 may be provided on both the main body of the projector 10 and on a white board 80 as a projection surface. According to the structure shown in FIG. 7, the projector 10 is attached to the tip of a bar-shaped fitting extended from the upper end of the white board 80. In this structure, the cantilevered projector 10 is greatly affected by vibration. Moreover, in the structure which allows the user to directly write to the white board 80 with a pen, it is estimated that the level of vibration becomes larger than that in the suspension installation fixed to the ceiling 60 or the wall. Thus, when the technology of the invention is applied to the projector 10 combined with the white board as shown in the figure, more preferable advantages can be offered. According to the structure in this example which has the projection surface constituted by the white board 80, it is preferable that the image blur preventive control is performed based on the relative detection results obtained by the vibration sensor 14 equipped on the main body of the projector 10 and by the vibration sensor 14 equipped on the white board 80.

The respective parts included in the projector 10 described in the respective embodiments may be provided as a program. Moreover, this program may be stored in a recording medium (not shown) to be provided in the form of the recording medium. Thus, the program under which a computer functions as the respective units of the projector 10 and the recording medium storing the program are included in the scope of the appended claims of the invention. Other modifications of the embodiments such as the combination of the two embodiments which performs the image blur preventive control both for the projection systems 20 and 50 and for the image processing unit 17, for example, may be made without departing from the scope of the invention.

The entire disclosure of Japanese Patent Application No. 2010-013935, filed Jan. 26, 2010 is expressly incorporated by reference herein.

What is claimed is:

1. A projection apparatus comprising:
a projection system which projects an image;
a vibration detecting unit which detects vibration given to the main body of the apparatus;
an installation condition determining unit which determines the installation condition of the main body of the apparatus; and
an image blur preventive control unit which performs image blur preventive control for preventing blurring of the image caused by the vibration detected by the vibration detecting unit based on the vibration,
wherein the image blur preventive control unit performs the image blur preventive control in accordance with the installation condition determined by the installation condition determining unit.

2. The projection apparatus according to claim 1, wherein the image blur preventive control unit performs the image blur preventive control only when the installation condition determining unit determines that the main body of the apparatus is in a predetermined installation condition.

3. The projection apparatus according to claim 2, wherein the predetermined installation condition is a suspended condition from above.

4. The projection apparatus according to claim 1, further comprising:
a projection mode setting unit which sets a projection mode corresponding to the installation condition of the main body of the apparatus,
wherein the installation condition determining unit determines the installation condition of the main body of the apparatus based on the setting of the projection mode setting unit.

5. The projection apparatus according to claim 1, wherein the image blur preventive control unit performs the image blur preventive control for the projection system.

6. The projection apparatus according to claim 5, wherein the image blur preventive control unit executes angle control of an optical axis correction lens provided on the light entrance side of a projection lens as the image blur preventive control.

7. The projection apparatus according to claim 1, further comprising:
an image processing unit which carries out image processing for an inputted image signal,
wherein the image blur preventive control unit performs the image blur preventive control for the image processing unit.

8. An image blur preventive control method for a projection apparatus which projects an image, comprising:
allowing the projection apparatus to detect vibration given to the main body of the apparatus;
allowing the projection apparatus to determine the installation condition of the main body of the apparatus; and
allowing the projection apparatus to perform image blur preventive control for preventing blurring of the image caused by the vibration given to the main body of the projection apparatus and detected by the projection apparatus based on the vibration,
wherein the image blur preventive control performed by the projection apparatus for preventing blurring of the image is conducted in accordance with the detected installation condition of the main body of the projection apparatus.
